(19) United States
(12) Patent Application Publication
(10) Pub. No.: US 2010/0255347 A1
(43) Pub. Date: Oct. 7, 2010

(54) INFORMATION RECORDING MEDIUM AND METHOD FOR MANUFACTURING SAME

(76) Inventors: Yuuko Tomekawa, Osaka (JP); Morio Tomiyama, Nara (JP)

Correspondence Address: WENDEROTH, LIND & PONACK L.L.P., 1030 15th Street, N.W., Suite 400 East, Washington, DC, 20005-1503, US

(21) Appl. No.: 12/743,446

(22) PCT Filed: Oct. 27, 2008
(86) PCT No.: PCT/JP2008/003045

§ 371 Date: May 18, 2010

(30) Foreign Application Priority Data
Nov. 21, 2007 (JP) 2007-301489

(51) Int. Cl. G11B 5/33

(52) U.S. Cl. 428/800; 427/162; 427/558; 156/344

(57) ABSTRACT

A method for manufacturing an information recording medium may used for manufacturing the information recording medium which has a recording layer and a resin layer that may be provided in contact with the recording layer. In the method, the resin layer is made of at least two kinds of ultraviolet curing resins. First resin layer is formed by screen printing. Second resin layer is formed on the first resin layer as to compensate a surface property. Consequently, a surface nature of the resin layer can be improved.

### TECHNICAL FIELD

The present invention relates to an information recording medium used for reproduction or the recording and reproduction, and to a method for manufacturing the same.

### BACKGROUND ART

As the amount of information that information devices, audio/video devices, and so forth are required to handle has risen in recent years, there has been increasing attention give to optical disks and other such information recording media that provide easy data access, allow large volumes of data to be stored, and afford devices that are more compact, and this has led to higher density of recorded information. For instance, an optical recording medium with a capacity of about 25 GB with a single layer and about 50 GB with two layers, using a reproduction head with a numerical aperture (NA) of 0.85 as a converging lens for focusing a laser beam and using a laser beam with a wavelength of approximately 400 to 405 nm, has been proposed as a means for increasing the density of an optical disk, and has been marketed under the name of “Blu-ray disc.”

FIG. 2 is a cross section of a single-layer Blu-ray disc with a capacity of 25 GB. This Blu-ray disc is made up of a signal substrate 201 on one side of which is transfer-formed an information face of pits or guide grooves composed of a textured shape, a thin-film layer 202, a transparent substrate 204, and a transparent layer 203. The thin-film layer 202 is disposed over the face of the signal substrate 201 on which the textured shape is provided. The transparent layer 203 is provided to affix the thin-film layer 202 and the transparent substrate 204.

The signal substrate 201 is generally made by injection compression molding or the like, and the information face is transferred onto one side by a die called a stamper. An information recording layer is formed by forming a thin-film layer over this upper face. The thickness of the signal substrate 201 is about 1.1 mm. The thin-film layer 202 includes a recording film or reflective film, and is formed by sputtering, vapor deposition, or another such method on the side of the signal substrate 201 on which the pits or guide grooves are formed. The transparent substrate 204 is composed of a material that is transparent to the recording and reproduction light (has transmissivity), and its thickness is about 0.1 mm. The transparent layer 203 is provided to bond the two transparent substrates 204 and 205 together, and is formed from an adhesive agent such as a photosetting resin or a pressure-sensitive adhesive. The transparent substrate 204 and the transparent layer 203 are collectively referred to as a cover layer. Sometimes the cover layer is formed by just curing the transparent layer, without affixing a transparent substrate. The recording and reproduction of this multilayer information recording medium are accomplished by directing a recording and reproduction laser beam from the transparent substrate 204 side.

With an information recording medium such as this, the cover layer is usually made by spin coating with an ultraviolet curing resin or the like (see Patent Citation 1, for example).

Patent Citation 1: Japanese Laid-Open Patent Application 2005-259331

### DISCLOSURE OF INVENTION

However, a problem is that when the cover layer is formed by spin coating, there are slight fluctuations in film thickness in the peripheral direction, and major fluctuations in film thickness in the radial direction. Also, since the resin extends all the way to the end face of the coated substrate, when the spinning is halted and the resin is cured by optical irradiation, surface tension can cause the resin to build up at the end face of the coated substrate, resulting in a thicker film there. Consequently, the following problems are encountered in the recording and reproduction of signals to a medium with a laser. Spherical aberration caused by film thickness fluctuation can result in fluctuation in the focusing of the light spot, and can affect focus control of the light spot on the information face or tracking control in which the light spot is made to track a signal string. Also, with spin coating, controlling the conditions for achieving a uniform coating thickness is complicated, and performing spin coating for each layer results in a longer takt time.

Meanwhile, there is a method that employs screen printing technology, in which the information face of a substrate is coated (printed) with an ultraviolet curing resin or the like by sliding a squeegee over a screen, so as to form a resin layer. Advantages of this method are that it is relatively easy to shorten the takt time, the resin can be applied to the desired places by controlling the shape of the screen, and so forth.

However, screen printing involves applying a resin to a substrate through the mesh of a screen, so the resin tends not to adhere to the substrate at the lines that make up the screen or at the intersecting portions where the lines cross. Accordingly, the texturing reflects the shape of the screen.

As discussed above, when a laser is used to record and reproduce a signal, resin build-up can affect tracking control and focus control of the laser beam. Therefore, although screen printing is easy and affords a short takt time, a problem seems to be the condition of the resin surface. It is an object of the present invention to provide an information recording medium with which a stable reproduction signal can be obtained, and a method for manufacturing this information recording medium inexpensively.

The method for manufacturing a cover layer in the information recording medium of the present invention is a method for manufacturing an information recording medium in which a laser beam is directed at an information recording medium having an information recording film to perform signal recording and reproduction, and a resin layer on the side at which the laser beam is directed is formed from at least two kinds of ultraviolet curing resin, said method comprising the following steps.
forming a first resin layer over the information recording film by coating with a liquid first ultraviolet curing resin by screen printing; and
forming a second resin layer by coating with a second ultraviolet curing resin having a lower viscosity than the first ultraviolet curing resin, so that this second resin layer comes into contact with the first resin layer

The thickness of the first resin layer is preferably greater than the thickness of the second resin layer.

The method for forming the second resin layer is preferably screen printing.

The mesh count of the screen used in the screen printing to form the second resin layer is preferably greater than the mesh count of the screen used in the screen printing to form the first resin layer.

The method for forming the second resin layer is preferably inkjetting.

The method for forming the second resin layer is preferably spin coating.

Also, this method preferably further comprises the following steps.
affixing a substrate with a flat surface under a vacuum atmosphere to an information recording medium obtained by forming the first resin layer by screen printing and then coating this with the liquid first ultraviolet curing resin;
directing ultraviolet rays at the information recording medium and the flat substrate in a state in which they have been affixed
peeling the information recording medium and the flat substrate apart

In a step following the formation of the first ultraviolet curing resin, ultraviolet rays are preferably directed at the first ultraviolet curing resin for the purpose of curing it.

When an information recording medium is produced by the above method, the time it takes to form the resin layers can be shortened, and higher productivity can be anticipated. Also, since the equipment used for production is relatively simple, it will not require maintenance as often. Accordingly, a large-capacity information recording medium can be provided to the market inexpensively.

The information recording medium pertaining to another aspect of the present invention is an information recording medium which has an information recording layer, and in which a resin layer is formed over the information recording layer, wherein the resin layer is formed from at least two layers of resin. Of the resin layers, the center line average roughness of the first resin layer surface formed on the information recording layer is greater than the center line average roughness of the resin layer surfaces other than the first resin layer.

With this information recording medium, the center line average roughness of the first resin layer surface in the information recording medium is preferably greater than the center line average roughness of the outermost resin layer.

With the information recording medium of the present invention and the method for manufacturing the same, a resin layer can be formed on a recording layer in a short time. Also, since the center line average roughness of the surface of the second resin layer is very low, tracking control and focus control of the laser beam that records and reproduces signals can be stabilized, and an information recording medium with which signals can be favorably recorded and reproduced can be realized.

### BRIEF DESCRIPTION OF DRAWINGS

FIG. 1 consists of cross sections of an example of the resin application step in an embodiment of the present invention;

FIG. 2 is a schematic diagram of the configuration of a Blu-ray disc;

FIG. 3 is a cross section illustrating the configuration of a recording film;

FIG. 4 is a diagram of the configuration of a device for recording and reproduction of signals to and from an information recording medium;

FIG. 5 is a diagram of the surface texturing of an information recording medium and the incidence angle of a reproduction laser beam;

FIG. 6 is a diagram of the screen and signal substrate in an embodiment of the present invention;

FIG. 7 is a detail view of a screen and cross sections of resin in an embodiment of the present invention;

FIG. 8 is a graph of the relation between resin viscosity and surface roughness when screen printing is performed;

FIG. 9 consists of cross sections illustrating an example of the affixing step in an embodiment of the present invention;

FIG. 10 consists of schematic diagrams of an inkjetting step in an embodiment of the present invention;

FIG. 11 illustrates the application of the two types of ultraviolet curing resin in an embodiment of the present invention;

FIG. 12 is a cross section of a multilayer information recording medium in an embodiment of the present invention;

FIG. 13 is a cross section illustrating the configuration of the recording film of a multilayer information recording medium in an embodiment of the present invention; and

FIG. 14 consists of cross sections illustrating an example of the resin application step in an embodiment of the present invention.

### KEY

101 squeegee fixing jig

102 squeegee

103 first type of ultraviolet curing resin

104 screen

105 screen frame

106 table

107 signal substrate

108 thin-film layer

109 arrow

110 first type of resin layer

111 ultraviolet irradiation device

112 second type of ultraviolet curing resin

113 screen

114 squeegee fixing jig

115 squeegee

116 arrow

117 second type of resin layer

118 ultraviolet irradiation device

### BEST MODE FOR CARRYING OUT THE INVENTION

Embodiments of the present invention will now be described through reference to the drawings. These embodiments illustrate structural examples of information recording media in the form of optical disks, but the commercial product that is produced is not limited to being in the form of an optical disk. A manufacturing method and manufacturing apparatus with which a resin layer can be formed at high speed and in a uniform thickness are proposed below.

The steps of producing a recording medium and of recording and reproducing information span a number of processes, so each process will be described through reference to the drawings.

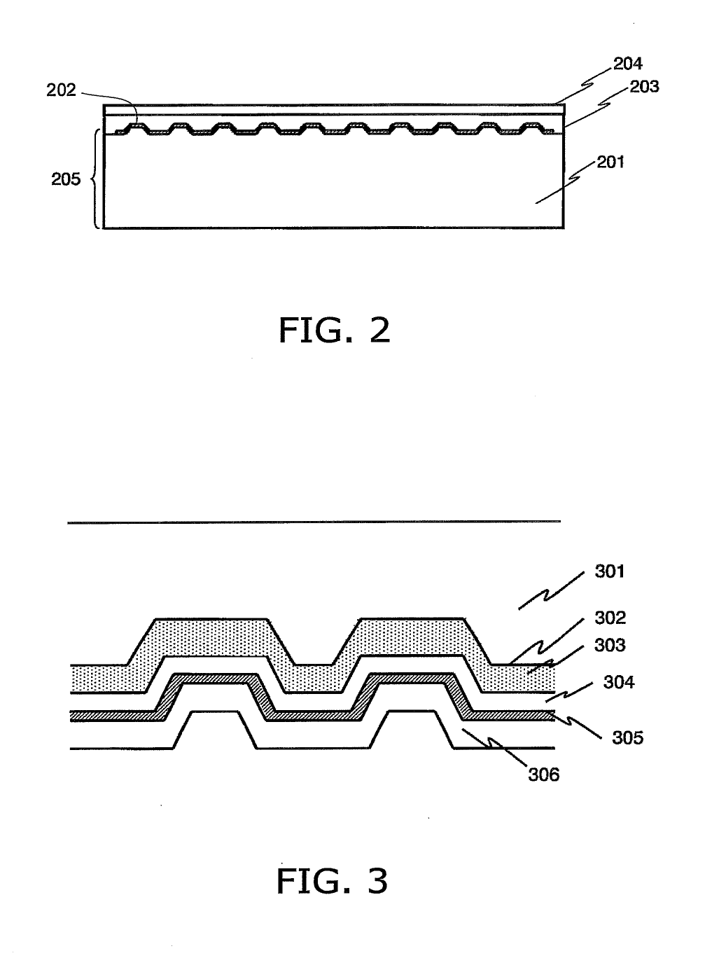

First, the process up to the formation of a cover layer in a Blu-ray disc will be described through reference to FIG. 2.

The signal substrate 201 is formed from a disk of polycarbonate or acrylic resin, with an outside diameter of 120 mm and a thickness of about 1.0 to 1.1 mm, so that the substrate will have good rigidity and be resistant to warping, and so that there will be good thickness interchangeability with CD's, DVD's, and other such optical disks. An information face such as pits or guide grooves formed by texturing is produced on one side of the signal substrate 201 by using a die called a stamper to mold the resin by injection compression molding or the like. A center hole (not shown) with a diameter of 15 mm is provided to the center part of the substrate in order to support and rotate the disk when a player records or reproduces a signal. In this embodiment, a case in which polycarbonate is used will be described as a typical example.

Since the transparent layer 203 and so forth composed of a photosetting resin material are laminated over the signal substrate 201, if the information face is on top, for example, the information recording medium ends up warping in a concave shape due to photosetting constriction, which is a characteristic inherent in photosetting resins. Therefore, to deal with warping of the signal substrate 201, the information face is put on top and formed warped in a convex shape ahead of time, so that after the cover layer has been laminated, the warping of the information recording medium is flattened out.

A characteristic of the thin film layer 202 is that it reflects the reproducing laser beam if the information recording medium is intended to be a ROM. For example, a thin film of a dielectric, a semiconductor, or a metal such as aluminum, silver, gold, silicon, or SiO₂ is formed by sputtering, vapor deposition, or another such method.

The configuration of a recording film when the information recording medium is intended for write-once application will now be described through reference to FIG. 3. An information face 302 has pits or guide grooves. A reflective film 303 composed of AlCr, a ZnS film 304, a TeOPd recording film 305, and a ZnS film 306 are formed in that order over the information face 302, which is on a first signal substrate 301. These films are formed by sputtering, vapor deposition, or another such method. A case of using aluminum as the reflective film 303 will be described as a typical example, but just as with a ROM, a material whose main component is a metal such as silver or gold may be used. It is also possible to use a configuration that includes a colorant film or the like as a thin-film layer.

As for the steps, a cover layer is formed over the signal substrate on which the reflective film or recording film has been formed, but since this step is discussed in detail below, first we will describe the method for recording and reproducing the information recording medium.

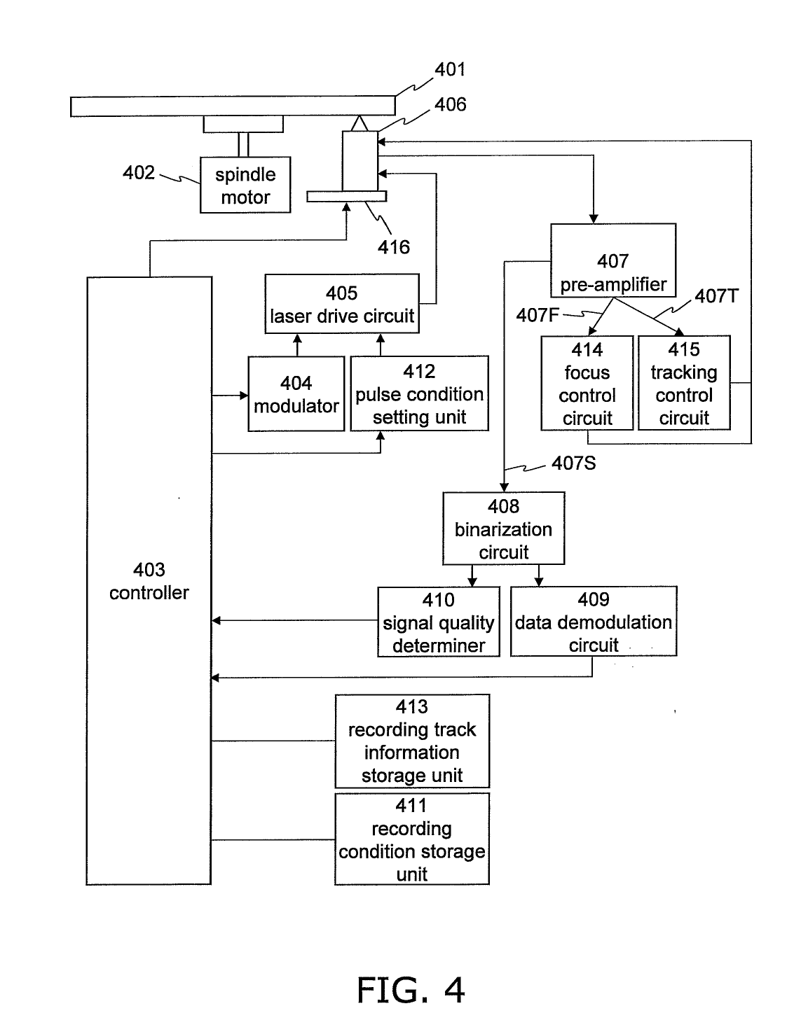

Here, the method for recording and reproducing information to and from a multilayer information recording medium, and an example of the mechanism of a recording and reproduction device, will be described through reference to FIG. 4, which is a diagram of a device for recording and reproduction to and from a multilayer information recording medium.

This drawing shows a state in which an information recording medium 401 has been loaded. This recording and reproduction device has the various devices listed below. A spindle motor 402 mounts and turns the information recording medium 401. A controller 403 executes various kinds of control. A modulator 404 converts the data to be recorded into a recording signal. A laser drive circuit 405 drives a semiconductor laser according to a recording signal. An optical head 406 has a semiconductor laser, converges a laser beam on the medium, and performs the recording of information, and also obtains reproduction signals from reflected light. A pre-amplifier 407 amplifies reproduction signals, and generates an information reproduction signal 407S, a focus error signal 407F, and a tracking error signal 407T. A binarization circuit 408 converts the information reproduction signal 407S into a binary signal. A data demodulation circuit 409 demodulates data from the binary signal. A signal quality determiner 410 determines the quality of a signal obtained by the test recording of specific data in a test recording region of the medium. A recording condition storage unit 411 stores optimal recording conditions obtained by a learning operation. A pulse condition setting unit 412 controls laser pulses according to the above-mentioned recording conditions. A recording track information storage unit 413 stores recording track information read from the information recording medium 401. A focus control circuit 414 controls the optical head 406 on the basis of the focus error signal 407F so that the laser beam will be focused on the recording layer of the information recording medium 401. A tracking control circuit 415 controls the optical head 406 on the basis of the tracking error signal 407T so that the laser beam will properly scan the track of the information recording medium 401. A movement unit 416 moves the optical head 406 in the radial direction of the information recording medium 401.

Here, the focus error signal 407F is generated by a standard method called the astigmatism method. The tracking error signal 407T is generated by a standard method called the push-pull method.

First, in the start-up step, the information recording medium 401 is loaded onto the spindle motor 402 and rotated, after which a laser beam for reproducing information is directed onto the information recording medium 401 by the optical head 406, and focused on the recording layer.

The reproduction of recording track information and so forth is performed by using the data demodulation circuit 409 to demodulate a signal obtained by binarizing the information reproduction signal 407S with the binarization circuit 408, and sending this product to the controller 403. The information reproduction signal 407S is obtained by the optical head 406 from reflected light from the information recording medium 401. The binarization circuit 408 is set to a predetermined binarization slice level. Thus, the recording track information recorded to the information recording medium is read out.

Also, in recording, specific data outputted from the controller 403 is converted by the modulator 404 into a laser drive signal, and the laser drive circuit 405 drives a semiconductor laser disposed at the optical head 406 according to the laser drive signal. The optical head 406 records the signal in the recording region of the information recording medium 401. More specifically, light outputted from the semiconductor laser is converged on the information recording medium 401, and the laser beam tracks the grooves or lands of the track on the basis of the recording track information.

The following method is used to determine whether or not the signal is properly recorded or reproduced to or from the information recording medium 401. A signal obtained by binarizing with the binarization circuit 408 the reproduction signal for data recorded as above is compared with data outputted from the controller 403 during recording.

With a reproduction-only multilayer information recording medium, pits consisting of bumps and recesses and that serve as information are formed on the multilayer information recording medium, and the tracking error signal 407T is reproduced by a standard method called a differential push-pull method. Therefore, the laser beam tracks the string of pits, and only the reproduction of information is performed.

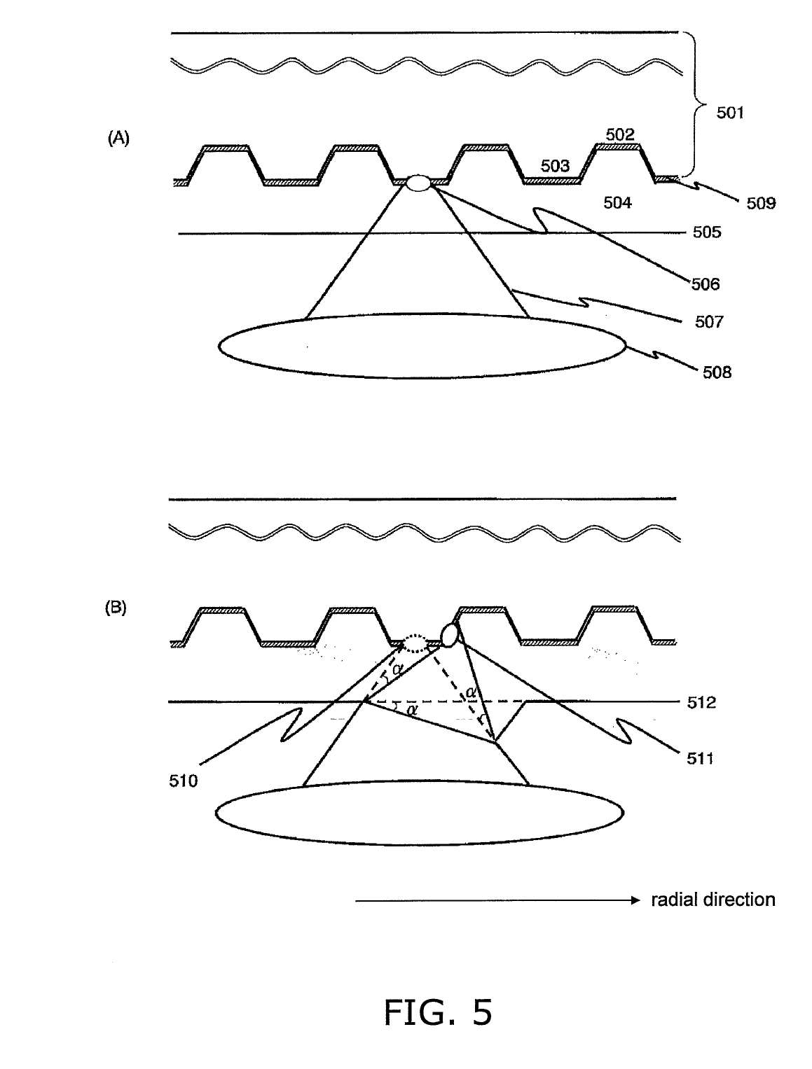

The mechanism by which the reliability of information is lost depending on the presence of surface roughness of the cover layer will be described through reference to FIGS. 5A and 5B, which are cross sections of the information recording medium during reproduction. FIG. 5A shows a case in which surface roughness is not expressed on the cover layer of the information recording medium, and FIG. 5B shows a case in which surface roughness is expressed on the cover layer of the information recording medium. FIG. 5 shows an information recording medium with a single-layer structure (in which there is only one recording layer), but this phenomenon can also occur with a multilayer information recording medium having a plurality of recording layers.

In the drawings, 501 is a signal substrate, which is a substrate on which pits, guide grooves, or another such information face consisting of texturing has been formed on one side. This phenomenon occurs regardless of whether the texturing formed on the signal substrate 501 is pits or guide grooves, but the drawings illustrate a case of guide grooves. In the texturing formed on the signal substrate 501, the portions that are convex as seen from the laser beam incident side are called grooves 503, and the portions that are concave are called lands 502. In the case of a Blu-ray disc, at a disk capacity of 25 GB, the track pitch is about 320 nm. Thus, the length of one set of a groove 503 and a land 502 is about 320 nm. If the sizes of the lands 502 and grooves 503 are substantially the same, the width of a groove is about 160 nm. 509 is a thin-film layer on which the information face of the signal substrate 501 face is formed, and 504 is a cover layer formed over the thin-film layer 509. The cover layer surface is numbered 505. In this drawing, a case is shown in which the cover layer is formed from a single layer of resin. 507 is a laser beam for reproducing or recording information, 506 is a beam spot converged on the thin-film layer 509, and 508 is an objective lens 508 that converges the laser beam 507 on the thin-film layer 509, and is disposed in an ordinary optical head (not described).

The effect of defects in the reproduction of information from an information recording medium will now be described, but the same thing happens during recording.

When a signal is reproduced from an information recording medium, the laser beam 507 is focused on the desired thin-film layer. In the drawing, it is converged on the beam spot 506.

Here, if we follow the path of the laser beam, we see that first the laser beam 507 converged by the objective lens 508 passes through in a luminous energy obtained by multiplying the transmissivity of the cover layer 504 by the amount of incident light. Here, since air and the cover layer 504 have different indexes of refraction, the sine ratio between the laser beam incidence angle and the refraction angle of the cover layer 504 is different.

The wavelength of the laser beam used with a Blu-ray disc is close to 405 nm, and the refractive index with respect to this wavelength is 1.00 in air, while the refractive index used for the cover layer 504 varies with the material, but a resin or a sheet with an index of at least 1.45 and no more than 1.70 is generally used.

The laser beam 507 that has passed through the cover layer 504 is converged on the thin-film layer 509, goes back in the opposite direction from that of the incident light, and is incident on a detector (not shown) that converts the intensity of the light into an electrical signal. The laser beam 507 is reflected by the thin-film layer 509 in a luminous energy obtained by multiplying the reflectivity of the thin-film layer 509 by the emitted luminous energy, and the luminous energy is thereby reduced again by the transmissivity of the cover layer 504. As a result, data is read.

In the recording and reproduction of an information recording medium, the lens is designed so as to minimize various kinds of aberration in order to record and reproduce signals more accurately. Furthermore, a focus control circuit 414 words to reduce the light spot diameter on the thin-film layer 509 in order to reduce variance even with a smaller recording mark.

As in FIG. 5A, when there is no surface roughness on the cover layer 504, a signal can be reproduced from the desired information layer by going through the above-mentioned optical path.

In FIG. 5B, meanwhile, there is roughness on the surface of the cover layer 512. This drawing shows a case in which the cover layer surface is tilted by an angle α. In this case, the laser beam 507 is incident such that it is inclined by a from the incidence angle that it is supposed to have with respect to the cover layer 504, and does not follow the path it is supposed to take through the cover layer 504. This offset in incidence angle causes the focal point of the beam to be at a location 511 that is different from the beam spot 510 where the focal point is supposed to be. This is a serious impediment to the accurate recording and reproduction of signals. The amount of offset in the radial direction of the location 511 away from the beam spot 510 where the focal point is supposed to be is generally called the off-track amount, and offset in the thickness direction of the disk is called the defocus amount. With an ordinary Blu-ray disc, the width of the grooves 503 is somewhere around 160 nm, so the off-track amount should be well below this value. Also, with an ordinary Blu-ray disc recording and reproduction device, some leeway is ensured with respect to a defocus amount of about 5 μm. Accordingly, the defocus amount should be well below 5 μm. That is, the off-track amount needs to be approximately 30 times smaller, so it can be said that the off-track amount determines the minimum value for surface roughness more so than the defocus amount. Therefore, texturing of the cover layer 512 surface is preferably as small as possible so that the off-track amount will be at or under the desired level.

The above is an example of a method for manufacturing a multilayer information recording medium, and a method for the recording and reproduction of information. In the embodiments that follow, a method for manufacturing a cover layer will be described in detail as a specific example of the effect of the invention.

### EMBODIMENT 1

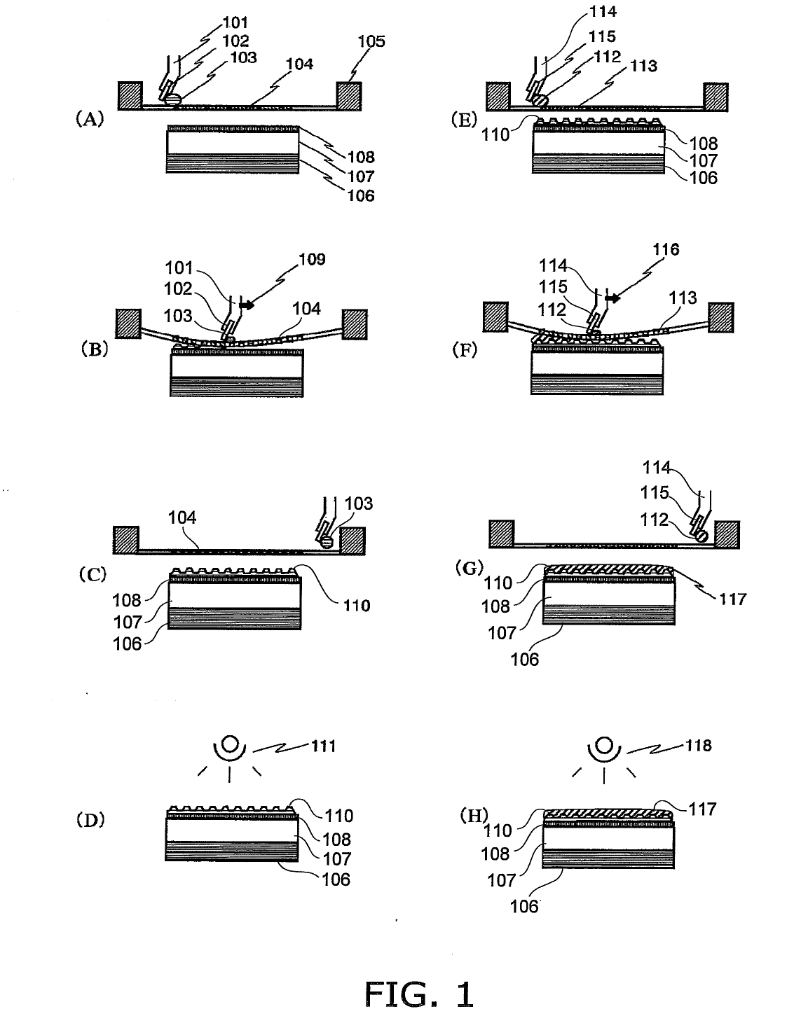

A method for manufacturing the cover layer of the multilayer information recording medium of the present invention will now be described through reference to FIG. 1. FIG. 1 consists of cross sections of an example of the resin application step in an embodiment of the present invention. FIGS. 1A to 1D schematically illustrate the formation of a first type of resin layer constituting the cover layer, and FIGS. 1E to 1H schematically illustrate the formation of a second type of resin layer.

FIG. 1A shows a squeegee fixing jig 101, a squeegee 102, an ultraviolet curing resin 103, a screen 104, a screen frame 105, a table 106, and a signal substrate 107. A thin-film layer 108 is a single-layer thin film formed on the signal substrate 107.

When a screen printing apparatus is used to apply the resin, first the setting of the printing apparatus is performed. First, the squeegee 102 is attached to the squeegee fixing jig 101. Here, the bottom face of the squeegee 102 with respect to the table 106 is adjusted so that the degree of parallelism is low. This degree of parallelism affects thickness unevenness of the resin layer in the disk plane, so the lower the degree of parallelism between the squeegee 102 and the table 106, the better.

The squeegee fixing jig 101 is preferably made of a material with excellent rigidity, such as stainless steel. The squeegee 102 is preferably made of a material that is chemically stable with respect to the ultraviolet curing resin 103, and that exhibits rubber-like elasticity. This is because during printing, the squeegee 102 is repeatedly rubbed against the gauze of the screen 104 in a state of being in contact with the ultraviolet curing resin 103.

Next, the screen 104 is put in place. Here again, just as with the squeegee 102, the degree of parallelism with the table 106 is important.

Then, the thin-film layer 108, which contains a recording film material or a reflective film material, is formed on the upper surface of the signal substrate 107 by sputtering, vapor deposition, or another such method on the side on which the information face (pits or guide grooves) is formed. If needed, the opposite side of the signal substrate 107 from the side on which the thin-film layer 108 is formed is fixed on the table 106 by vacuum chucking or other such means.

Meanwhile, the screen 104 is provided so that the film can be formed in a uniform thickness by limiting the amount of ultraviolet curing resin 103 that passes through the openings.

The method for producing the screen 104 will now be described. Gauze that serves as the screen material is stretched over the screen frame 105 and coated with a photosensitive emulsion. Then, a light-blocking mask is placed over everywhere except the specific locations coated with the screen material (locations that form a plurality of holes), and the screen material is irradiated for a specific length of time with ultraviolet rays from an exposure apparatus. The photosensitive emulsion exposed to this ultraviolet ray irradiation is developed by rinsing it with water (such as a water jet), which gives the screen 104.

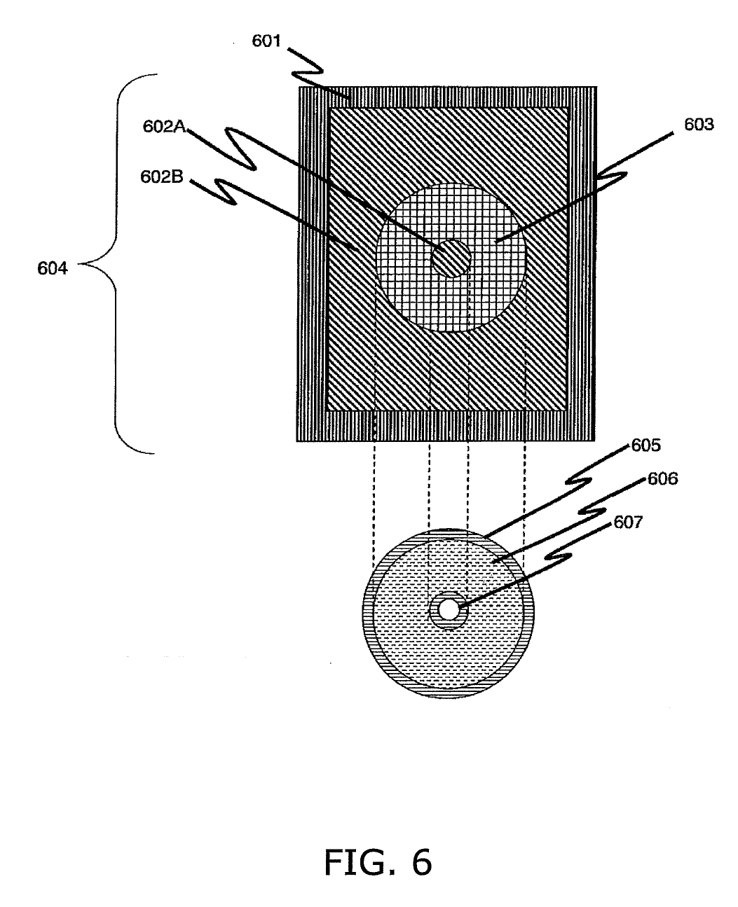

The relation between the screen and the coated region of the signal substrate will be described through reference to FIG. 6. In this embodiment, the portions where the photosensitive emulsion remains on the gauze because of the light-blocking mask correspond to regions 602A and 602B, and the portion where the gauze is exposed by the exposure light corresponds to 603.

Wood, aluminum, stainless steel, plastic, or another such material can be used, for example, for a screen frame 601, but aluminum is particularly favorable because of its light weight and high rigidity. The gauze that serves as the screen material can be silk, Nylon®, Tetoron®, V-Screen®, stainless steel, or the like. Since the screen directly touches the surface of the signal substrate, it is preferably made of a pliant material. Accordingly, it is better to use an organic material such as Nylon rather than a metal material such as stainless steel. The photosensitive emulsion can be one obtained, for example, by mixing and dissolving a diazonium salt or a dichromate in a PVA or vinyl acetate emulsion. The mesh count at a specific location of the screen material (the number of lines per inch) is preferably from 50 to 600. If the mesh count is within this range, the screen can be coated with the resin-containing material without encountering problems such as coating unevenness or the resin-containing material not passing through properly. Furthermore, the holes in the screen are not limited to being in mesh form.

In this embodiment, a case is described in which lightweight and highly rigid aluminum is used as the screen frame 601, and V-Screen is used so as to reduce the load on the signal substrate, but the same effect can be obtained using other materials.

If the viscosity of the resin is low, the resin will flow after coating, so the resin will end up bulging out at the end faces or building up. If the resin viscosity is high, it will be difficult for the resin to be transferred through the screen. If we take into account such factors as the effect of decreased resin viscosity due to temperature changes during the process, the viscosity of the resin is preferably between 30 and 10,000 cps.

The range of coating of the signal substrate 606 with the ultraviolet curing resin can be limited by selecting the opening formation region 603 of the screen 604. Thus, in this embodiment, the end position of the resin that is formed can be controlled by varying the boundary between the opening formation region 603 and the portion 602A where the photosensitive emulsion remains on the gauze.

When resin coating is performed by screen printing using the screen 604, the resin coated region is indicated by 606. In this embodiment, the signal substrate 605 is one in which the diameter of the hole 607 is 15 mm, and the outside diameter is 120 mm. The screen 604 is such that the boundary between the portion 602A where the photosensitive emulsion remains on the gauze and the opening formation region 603 is at a diameter of 20 mm, and the boundary between the portion 602B where the photosensitive emulsion remains on the gauze and the opening formation region 603 is at a diameter of 119.8 mm.

As shown in FIG. 1A, the ultraviolet curing resin 103 is dripped ahead of the squeegee 102 in its forward direction. In this embodiment, the viscosity of the ultraviolet curing resin 103 is 4000 cps, and the mesh count of the screen 104 is 70. The viscosity of the ultraviolet curing resin used to form the first resin layer is preferably from 500 to 10,000 cps.

In FIG. 1B, the squeegee 102 is rubbed while being pushed into the screen 104 in the direction of the arrow 109, which coats the signal substrate 107 with the ultraviolet curing resin 103. This operation causes a first type of ultraviolet curing resin 103 to be pushed in and pass downward through an opening area between the threads of the screen 104, and coating with the resin is possible by bringing this into contact with the thin-film layer 108.

FIG. 1C shows the first type of resin layer 110 that has been formed. This coating step allows the first type of resin layer 110 to be formed in an average thickness of 80 μm. The surface shape of the first type of resin layer 110 is to a great extent due to the characteristics of the ultraviolet curing resin 103 and to the separation of the screen 104. The center line average roughness Ra of the surface immediately after the formation of the ultraviolet curing resin 103 here is 14 μm. The surface shape of the first type of resin layer 110 will be discussed in detail below.

In FIG. 1D, the first type of resin layer 110 is cured using an ultraviolet irradiation device 111 from above the first type of resin layer 110. In FIG. 1E, the signal substrate 107 is moved below a screen 113 that applies a second type of ultraviolet curing resin 112, in a state in which the cured first type of resin layer 110 is on top. In this step, the viscosity of the second type of ultraviolet curing resin 112 is 100 cps, and the mesh count of the screen 113 is 300. Just as in the previous step, a squeegee 115 is fixed by a squeegee fixing jig 114. In FIG. 1F, just as in the step of FIG. 1B, the squeegee fixing jig 114 and the squeegee 115 are pushed into the screen 113 while being moved in the direction of the arrow 116. The second type of ultraviolet curing resin 112 is passed through the opening area between the threads of the screen 113, and a second type of resin layer 117 is formed over the cured first type of resin layer 110.

FIG. 1G shows the second type of resin layer 117 formed in an average thickness of 20 μm and in contact with the first type of resin layer 110. Since the second type of resin layer 117 here is low in viscosity, it fills in the recesses in the first type of resin layer 110, providing a leveling action that corrects surface roughness of the first type of resin layer 110. If an ultraviolet curing resin with a high surface tension is selected for the second type of ultraviolet curing resin 112, there will be a greater force that acts to reduce surface area of the second type of resin layer 117, that is, the atmosphere contact area, so the effect is to enhance the leveling action. Also, leaving a longer time from the coating with the second type of resin layer 117 until the curing of the resin allows the second type of resin layer 117 to move, which improves the surface condition.

In FIG. 1H, after the second type of resin layer 117 has been applied and leveling completed, an ultraviolet irradiation device 118 is used to bathe the coating in ultraviolet rays and cure the second type of resin layer 117. The center line average roughness of the second type of resin layer 117 after curing is 1 μm or less.

Thus, with a cover layer composed of the first type of resin layer 110 and the second type of resin layer 117, the center line average roughness of the surface of the second type of resin layer 117 is greater than the center line average roughness of the surface of the first type of resin layer 110.

It is important for a thick-film resin layer of about 80 μm, as in this embodiment, to be formed by screen printing, and, to improve the surface condition, for the viscosity of the first type of resin to be greater than the viscosity of the second type of resin.

Another condition is that when the second resin layer is also formed by screen printing, it is important for the mesh count of the screen used in forming the first resin layer to be less than the mesh count of the screen used in forming the second resin layer.

According to the above conditions, at least half of the desired thickness is formed by the thickness of the first type of resin layer.

Thus, the following outstanding effect is obtained since the mesh count of the screen used in screen printing for forming the second resin layer is greater than the mesh count of the screen used in screen printing for forming the first resin layer. In forming the first resin layer, a thick first resin layer can be formed in a short time by using a coarse screen. In this case, it is effective for the resin to have a higher viscosity. In forming the second resin layer, a resin with a low viscosity is passed through a fine screen. The second resin layer ensures an excellent surface condition. As a result, a stable reproduction signal is obtained with the information recording medium.

The mesh count of the screen used to form the first resin layer is 70, and is preferably between 50 and 80. The mesh count of the screen used to form the second resin layer is 300, and is preferably between 150 and 450.

The thickness of the first resin layer is 80% of the total resin layer, and is preferably at least 50%. More preferably, the thickness of the first resin layer is from 80 to 90% of the total resin layer.

Next, the surface condition of each resin layer will be described. In this embodiment, the center line average roughness Ra of the surface of the first type of resin layer 110 is 14 μm, as mentioned above. This center line average roughness is measured according to standard No. JIS B 0601. In the case of screen printing, this center line average roughness Ra is generally proportional to the coating film thickness. This is because if the goal is to apply a thick coating of the resin layer, a large opening area must be obtained by using a coarse screen that has thick threads.

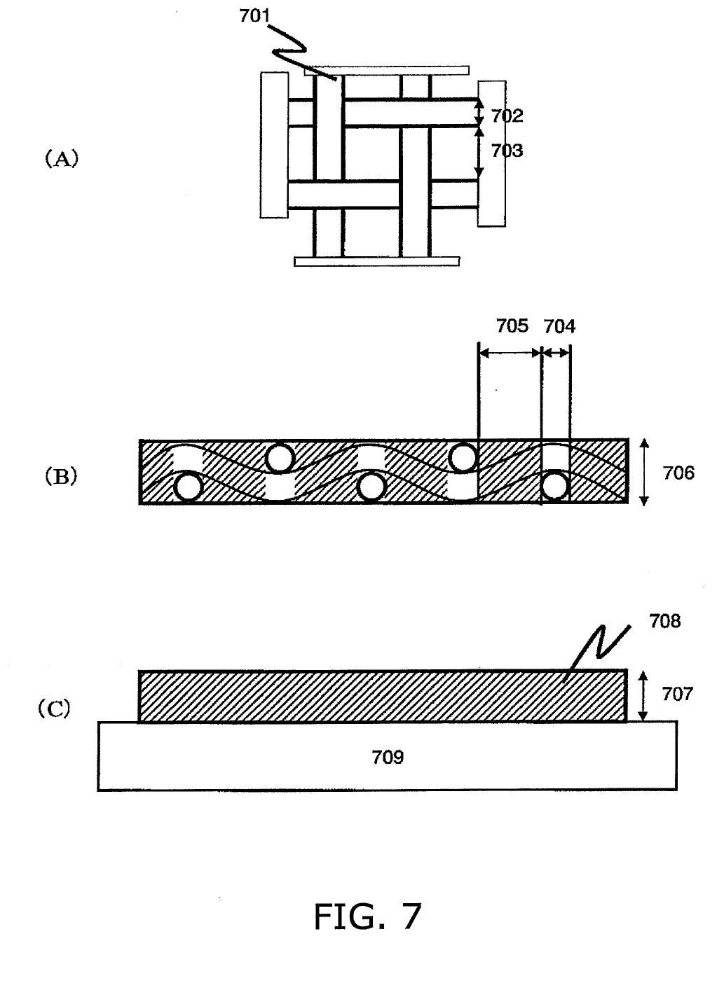

The resin coating thickness and the mesh shape of the screen will be described through reference to FIG. 7. FIG. 7A is a detail view of the mesh of the screen. 701 is one of the threads forming the screen, and 702 is the thread diameter. 703 is the spacing width between the threads. The screen is cut and shown in cross section in FIG. 7B. In FIG. 7B, 704 is the thread diameter, and 705 is the spacing width between the threads. 706 is the thickness of the screen including an emulsion. The screen thickness 706 is closely related to the thread diameter 704, and the greater is the thread diameter 704, the greater is the thickness 706 of the screen. FIG. 7C shows when this screen is used to form the resin layer 708 on the substrate 709. The thickness of the resin layer 707 shall be termed 707. If the screen and the resin layer thickness are defined as in FIG. 7, the thickness 707 of the resin layer can be expressed by the following formula.

(resin layer thickness 707)=(spacing width 703 between threads)^{2×}(screen thickness 706)÷(spacing width 703 between threads+thread diameter 704)²

In actual screen printing, not all of the resin injected into the spacing width between threads actually adheres to the substrate and forms a resin layer, so the resin layer is formed on the substrate 709 in a resin volume that is a certain percentage lower than what is calculated from the formula. Thus, if the goal is to increase the thickness 707 of the resin layer, it is better to use a screen with a greater thickness 706, that is, a greater thread diameter 704.

Also, the resin layer tends not to be formed where the screen threads 701 and the substrate 709 are in contact, and the resin layer is instead formed where the substrate 709 is in contact with the spaces 705 between threads. Therefore, the texturing on the surface of the resin layer 708 that is formed closely reflects this screen shape. That is, when a screen with a large thread diameter 704 is used, there will be a larger surface area over which it is difficult to form a resin layer on the substrate, and the thickness 706 of the screen will increase. As a result, a greater volume of resin will be encompassed within the spacing width between threads, so the texturing width of the resin layer 708 that is formed will be greater.

In other words, when screen printing is used to form a thick resin layer, there is greater surface texturing of the resin layer that is formed. Accordingly, this is not suited to the formation of resin layers that need to have very good surface condition, such as the resin layer on the side where a laser beam is incident on a Blu-ray disc or the like.

In view of this, just as in this embodiment, two or more resin layers of different viscosity are used, so that even though the surface condition is poor with the first layer, it does provide resin layer thickness, and a second resin layer with a lower viscosity is formed for the sake of leveling, which improves the surface condition of the first layer. As a result, it is possible to ensure the desired surface condition of the resin layer.

Two kinds of ultraviolet curing resin were used in this embodiment, but the following problems are assumed. When the laser beam is incident and a signal is recorded or reproduced, the laser beam passes through the interface between the two ultraviolet curing resins. If the two kinds of ultraviolet curing resin here have greatly different indexes of refraction, then the laser beam will be scattered at the interface between the two ultraviolet curing resins, resulting in a loss of energy of the outputted laser beam. Accordingly, this leads to problems such as the inability to record a distinct mark during recording. To avoid these problems, it is preferable if the difference between the indexes of refraction of the two kinds of ultraviolet curing resin is as small as possible with respect to the wavelength of the laser beam used for recording and reproduction. At the least, it is preferable is the difference between the indexes of refraction of the two kinds of ultraviolet curing resin with respect to the wavelength of the laser beam used for recording and reproduction is 0.1 or less.

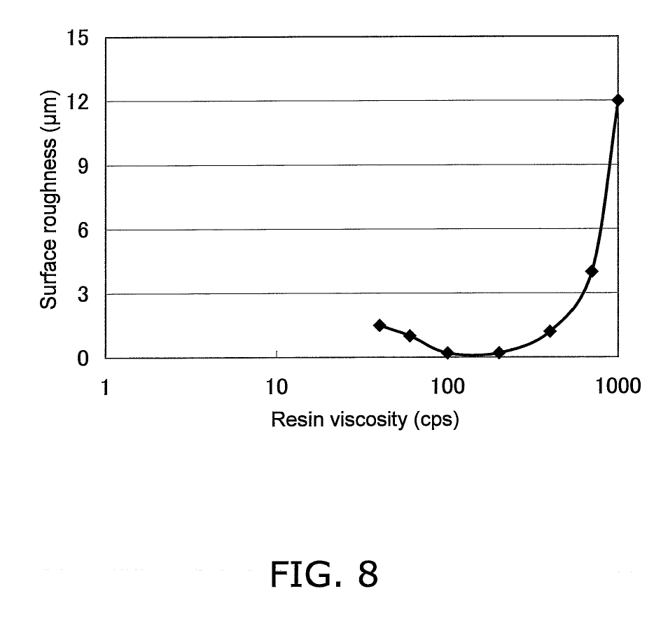

FIG. 8 shows the surface roughness when a coating of a resin with a viscosity of 40 to 1000 cps is formed by screen printing. Since leveling characteristics suffer when the viscosity is higher, the surface condition is inferior. The roughness Ra is preferably within 3 μm. Therefore, the viscosity of the second resin layer formed for the purpose of improving the surface condition is preferably less than 500 cps. Also, when actual screen printing is performed, a viscosity of 30 to 10,000 cps is preferable, so the viscosity range for the second resin layer is preferably greater than 30 cps and less than 500 cps.

### EMBODIMENT 2

In this embodiment, just as in Embodiment 1, the step of forming two types of ultraviolet curing resin is described. The difference from Embodiment 1 is the method for curing the first resin layer. In this embodiment, the surface condition of the first layer of ultraviolet curing resin is improved by affixing a substrate with an excellent surface condition in a vacuum atmosphere after the first layer of ultraviolet curing resin has been formed by screen printing. Also, in this embodiment spin coating, rather than screen printing, is used to product the second layer of ultraviolet curing resin. In spin coating, the ultraviolet curing resin is dripped onto the inner peripheral part of the substrate, and the substrate is spun to spread out the ultraviolet curing resin from the inner peripheral part.

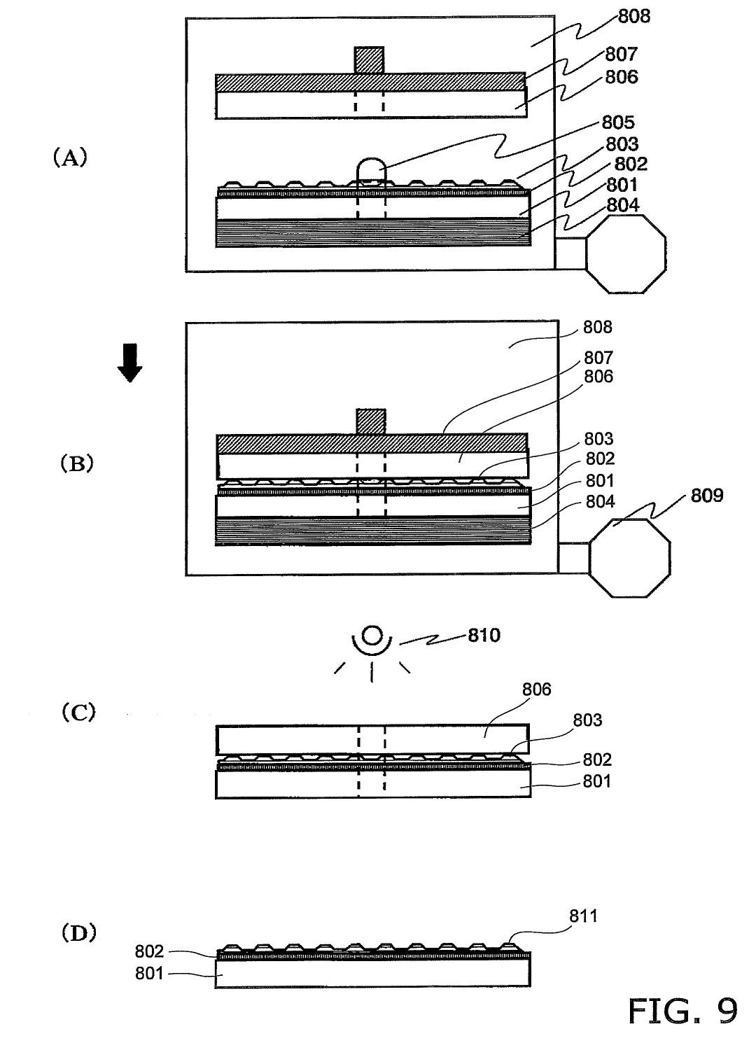

The affixing method for improving the surface condition of the first layer of ultraviolet curing resin will be described through reference to FIG. 9. First, in FIG. 9A is described the method for placing a sample in the affixing step. Just as in Embodiment 1, a recording layer 802 is formed over a signal substrate 801, and a resin layer 803 is formed by screen printing so as to be in contact with the recording layer 802. The surface condition of the resin layer 803 is not very good, since the layer was applied by screen printing. This signal substrate is placed on a table 804 in an affixing apparatus. A centering post 805 used for position adjustment is attached to this table 804, and its diameter is a few microns smaller than the diameter of the hole in the signal substrate 801. A transfer substrate 806 with a good surface condition is readied, and is placed so as to be opposite the signal substrate 801. In the drawing, the signal substrate 801 faces upward, and the transfer substrate 806 is placed above this, so the transfer substrate 806 is fixed by using a transfer substrate fixing piece 807 or the like. After the signal substrate 801 and the transfer substrate 806 have been placed inside a vacuum chamber 808, the vacuum chamber 808 is sealed shut.

Since the resin layer 803 has to be cured through the transfer substrate 806 in the ultraviolet ray irradiation ray (a subsequent step), the transfer substrate 806 preferably has high transmissivity to ultraviolet rays. Therefore, it is preferably made from a thin polycarbonate material or acrylic material, or from a quartz glass material or the like that has high transmissivity to ultraviolet rays, for example.

Next, in FIG. 9B, the air inside the vacuum chamber 808 is purged with a rotary pump, a mechanical booster pump, or another such vacuum pump 809, creating a vacuum atmosphere in a short time. In this embodiment, the transfer substrate 806 is superposed over the signal substrate 801 at the point when the inside of the vacuum chamber 808 has reached a degree of vacuum of 100 Pa or less. Here, the transfer substrate fixing piece 807 placed on the transfer substrate 806 has the role of a pressure plate, and presses on the transfer substrate 806 so that the surface shape of the transfer substrate 806 is transferred to the surface of the resin layer 803. Since the inside of the vacuum chamber 808 is a vacuum atmosphere, the resin layer 803 and the transfer substrate 806 can be affixed without any bubbles getting trapped in between.

After the affixing step is completed, the inside of the vacuum chamber 808 is returned to atmospheric pressure, and the affixed signal substrate 801 and transfer substrate 806 are taken out of the vacuum chamber 808. As shown in FIG. 9C, ultraviolet rays are emitted by an ultraviolet ray irradiation device 810 disposed above the transfer substrate 806, and the resin layer 803 is cured by irradiating the entire surface via the transfer substrate 806. Then, to separate the transfer substrate 806 at the interface between the resin layer 803 and the transfer substrate 806, compressed air is blown in between the transfer substrate 806 and the resin layer 803.

As shown in FIG. 9D, a cured resin layer 811 is formed through the above steps. The center line average roughness Ra of the surface of the resin layer 803 immediately after coating by screen printing here is about 14 μm. Meanwhile, the center line average roughness of the surface of the cured resin layer 811 obtained by going through this affixing step is 7 μm, so a significant improvement in the surface condition can be detected.

A spinning step will now be described as the step of applying the second type of ultraviolet curing resin.

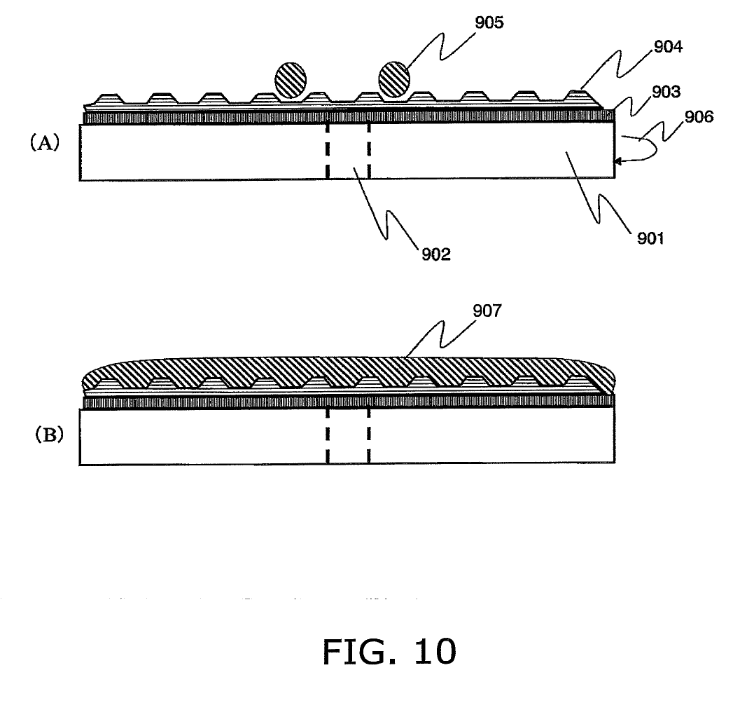

In FIG. 10A, a recording layer 903 is formed over a signal substrate 901, and the recording layer 903 is covered by a first type of resin layer 904. Usually, a center hole 902 is formed in the center of the signal substrate 901 to hold and rotate the signal substrate 901. A second type of ultraviolet curing resin 905 is dripped onto the center part of the signal substrate 901. The drip location is to the outside of the center hole 902 and to the inside of the signal region, and if the resin is dripped in a circular shape so that it coats 360 degrees, then the resin coating can cover the signal region. After the dripping of the resin, the signal substrate 901 is spun in a rotation direction 906. In this embodiment, the second type of ultraviolet curing resin 905 with a viscosity of 100 cps is spun for 20 seconds at a speed of 3000 rpm, and a second type of resin layer 907 can be formed, as shown in FIG. 10B. In the above case, if the resin is applied by centrifugal force, it will fill in the surface irregularities of the underlying first type of resin layer 904. As a result, a resin layer with an excellent surface condition can be formed. The thickness of the second type of resin layer 907 is 10 μm, and the center line average roughness Ra of the resin layer is 1 μm.

In this embodiment, a method is employed in which the surface condition of the first layer of ultraviolet curing resin is improved by affixing a substrate with an excellent surface condition in a vacuum atmosphere after the first layer of ultraviolet curing resin has been formed by screen printing, so the center line average roughness of the surface of the first type of resin layer 904 is lower than that in Embodiment 1. Therefore, either the center line average roughness of the surface of the second type of resin layer 907 is lower, or the conditions will be less stringent for obtaining the same surface center line average roughness.

Thus, with a cover layer composed of the first type of resin layer 904 and the second type of resin layer 907, the center line average roughness of the surface of the second type of resin layer 907 is lower than the center line average roughness of the surface of the first type of resin layer 904.

### EMBODIMENT 3

In this embodiment, the process of forming two ultraviolet curing resins is described just as in Embodiment 1, but inkjetting will be used to produce the second type of ultraviolet curing resin.

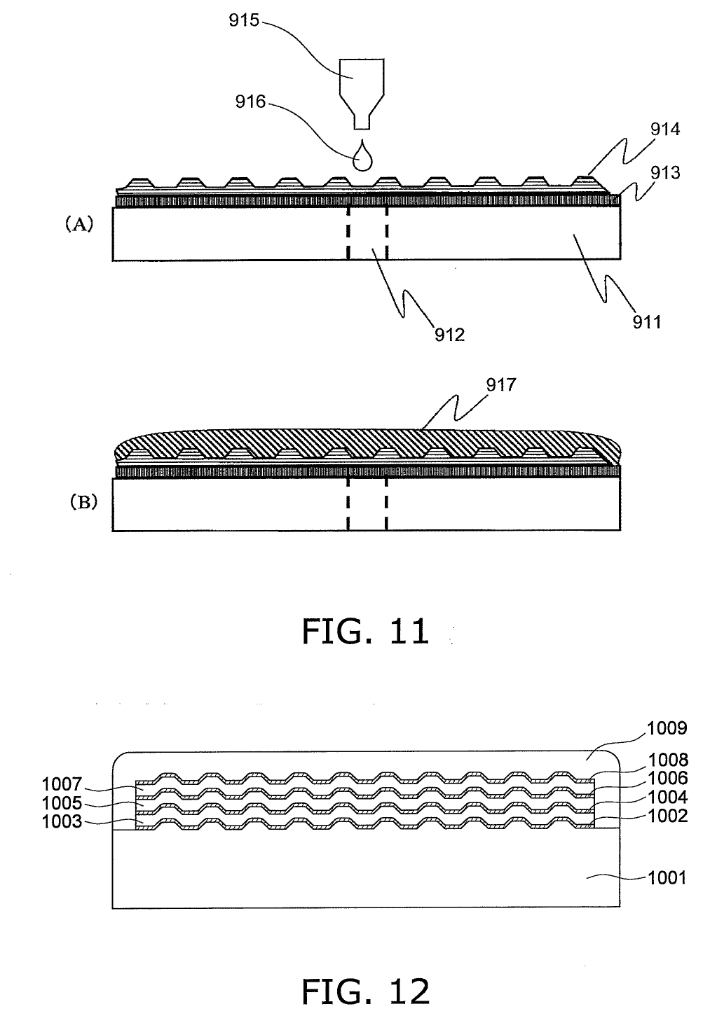

Just as in Embodiments 1 and 2, a recording film is coated with a first type of ultraviolet curing resin, and then cured by being irradiated with ultraviolet rays. With inkjetting, as shown in FIG. 11, a nozzle 915 ejects a resin 916, which improves the surface condition. Since the viscosity of the resin is 1 to 10 cps with inkjetting, the rough surface condition of the first type of resin layer can be improved.

With this embodiment, the mesh count of the screen is 50 lines per inch, and a first type of ultraviolet curing resin with a viscosity of 2500 cps is used, and is applied in a thickness of 80 μm so as to cover the recording film. Also, with inkjetting, an ultraviolet curing resin with a viscosity of 3 cps is used, and a second type of ultraviolet curing resin is formed in a thickness of 20 μm so as to cover the first type of ultraviolet curing resin.

### EMBODIMENT 4

In this embodiment, an optical information recording medium with a single-layer structure is used as an example, but the same applies to an information recording medium with a multilayer structure in which there are a plurality of recording layers, and resin layers are formed in between the recording layers.

FIG. 12 is a cross section of a multilayer information recording medium in an embodiment of the present invention. The multilayer information recording medium of the present invention comprises the following constitution. A first signal substrate 1001 is a thick substrate on one side of which is formed an information face such as pits or guide grooves. A first thin-film layer 1002 is disposed on the information face of the first signal substrate 1001. A second signal substrate 1003 has an information face such as pits or guide grooves disposed on the opposite side from that of the first signal substrate 1001. A second thin-film layer 1004 is disposed on the information face of the second signal substrate 1003. A third signal substrate 1005 has an information face such as pits or guide grooves disposed on the opposite side from that of the second signal substrate 1003. A third thin-film layer 1006 is disposed on the information face of the third signal substrate 1005. A fourth signal substrate 1007 has an information face such as pits or guide grooves disposed on the opposite side from that of the third signal substrate 1005. A fourth thin-film layer 1008 is disposed on the information face of the fourth signal substrate 1007. A transparent layer 1009 is disposed on the fourth thin-film layer 1008.

The first signal substrate 1001 is formed from a disk of polycarbonate or acrylic resin with an outside diameter of 120 mm and a thickness of about 1.0 to 1.1 mm, and has an information face such as pits or guide grooves formed on one side by injection compression molding or other such resin molding, so that the information recording medium will have good rigidity and be resistant to warping, and so that there will be good thickness interchangeability with CD's, DVD's, Blu-ray discs, and other such optical disks. A center hole (not shown) with a diameter of 15 mm is provided in the center part of the substrate and is used to hold and rotate the disk when a player records and reproduces a signal. The use of polycarbonate is described as a typical example in this embodiment.

The second signal substrate 1003, the third signal substrate 1005, and the fourth signal substrate 1007, which are intermediate layers composed of photosensitive resin materials, and the transparent layer 1009 are formed by lamination over the first signal substrate 1001. Accordingly, photosensitive contraction, which is a characteristic feature of photosensitive resins, causes the shape of the information recording medium after lamination to warp into a concave form when the information face is on top, for example. Therefore, to deal with warping of the first signal substrate 1001, the information face is put on top and formed warped in a convex shape ahead of time. As a result, after the second signal substrate 1003, the third signal substrate 1005, the fourth signal substrate 1007, and the transparent layer 1009 have been laminated, the warping of the information recording medium is flattened out.

A characteristic of the first thin-film layer 1002, the second thin-film layer 1004, and the third thin-film layer 1006 is that they reflect the reproducing laser beam if the information recording medium is intended to be a ROM. For example, a thin film of a dielectric, a semiconductor, or a metal such as aluminum, silver, gold, silicon, or SiO₂ is formed by sputtering, vapor deposition, or another such method.

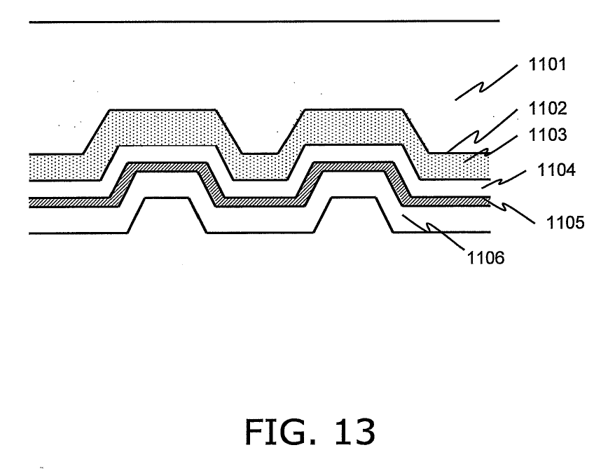

The configuration of a recording film when the information recording medium is intended for write-once application will now be described through reference to FIG. 13. The first thin-film layer 1002 will be used for the purposes of this description. First, a reflective film 703 composed of AlCr, a ZnS film 1104, a TeOPd recording film 1105, and a ZnS film 1106 are formed in that order, by sputtering, vapor deposition, or another such method, over the information face 1102, such as pits or guide grooves, formed on the first signal substrate 1001. A case of using aluminum as the reflective film 1103 will be described as a typical example, but just as with a ROM, a material whose main component is a metal such as silver or gold may be used. It is also possible to use a configuration that includes a colorant film or the like as a thin-film layer. The second thin-film layer 1004, the third thin-film layer 1006, and the fourth thin-film layer 1008 are formed as thin films just as is the above-mentioned first thin-film layer 1002. The thickness of the reflective layer 1103 may be adjusted, or the reflective layer 1103 may itself be removed, or the thickness of the ZnS film 1104 and the TeOPd recording film 1105 may be adjusted, according to the optical characteristics in recording and reproduction.

The second signal substrate 1003 is formed, for example, from an ultraviolet curing resin whose main component is acrylic, and which is substantially transparent (transmissive) with respect to the recording and reproduction light. Since ultraviolet curing resins have the following two characteristics, they are effective in terms of controlling the shape of the resin layers. First, since an ultraviolet curing resin has its curing light wavelength in the ultraviolet region, this prevents the resin from being cured by wavelengths other than ultraviolet rays. Second, an ultraviolet curing resin can be cured by irradiating it with ultraviolet rays whenever the opportunity presents itself. In this embodiment, after the first thin-film layer 1002 has been coated with the liquid ultraviolet curing resin, a signal transfer substrate, such as a substrate having an information face such as pits or guide grooves, is pressed against the coating. After this, the ultraviolet curing resin is cured by being irradiated with ultraviolet rays, and finally the signal transfer substrate is separated at the interface with the ultraviolet curing resin, thereby forming the second signal substrate 1003. The ultraviolet curing resin coating is formed smaller than the outside diameter of the first signal substrate 1001 and larger than the center hole in the first signal substrate 1001 (not shown). The third signal substrate 1005 and the fourth signal substrate 1007 are formed in the same shape and by the same method as the second signal substrate 1003 discussed above. The transparent layer 1009 is formed from an ultraviolet curing resin whose main component is acrylic, and which is substantially transparent (transmissive) with respect to the recording and reproduction light. The ultraviolet curing resin is used in liquid form, and is applied over the fourth thin-film layer 1008. The ultraviolet curing resins are formed so as to cover the various signal substrates and thin-film layers, and to be bonded to the first signal substrate at the inner peripheral part and outer peripheral part.

Again with a recording medium with multiple recording layers, if a conventional optical disk structure is employed, the length from the outermost surface of the transparent layer 1009 to the first thin-film layer 1002 is preferably about 100 μm. In this case, if we assume the minimum thickness of the second signal substrate 1003, the third signal substrate 1005, and the fourth signal substrate 1007 for the purpose of separating the thin-film layers, then the thickness of the resin layer of the transparent layer 1009 is to be 60 μm or less.

The method for forming the transparent layer 1009 in this embodiment will be described. This formation method can also be applied to the formation of the first signal substrate 1001, the second signal substrate 1003, the third signal substrate 1005, and the fourth signal substrate 1007. In particular, since the second signal substrate 1003, the third signal substrate 1005, and the fourth signal substrate 1007 have a thickness of about 10 μm, it is effective to use screen printing to form the first resin layer.

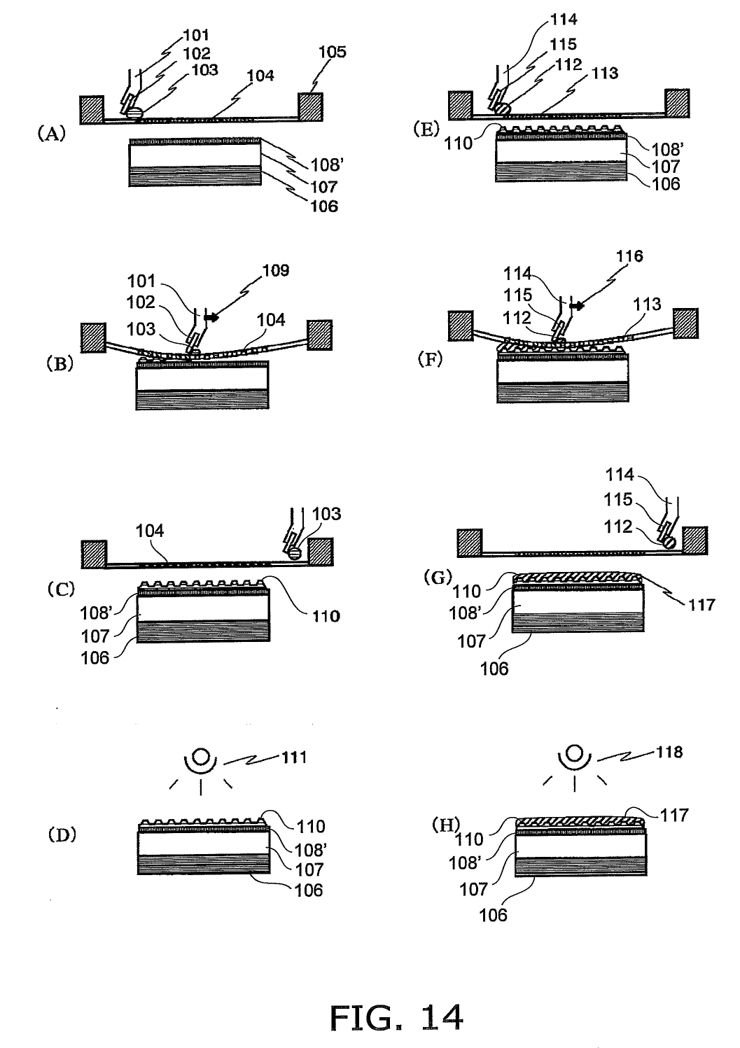

FIG. 14A shows the squeegee fixing jig 101, the squeegee 102, the ultraviolet curing resin 103, the screen 104, the screen frame 105, the table 106, and the signal substrate 107. A multilayer thin-film layer 108′ is constituted by alternating a plurality of thin-film layers and signal substrates.

When the resin is applied with a screen printing apparatus, first the printing apparatus setup is performed. The squeegee 102 is attached to the squeegee fixing jig 101. At this point the squeegee 102 is adjusted so that its degree of parallelism with respect to the table 106 is low. This degree of parallelism affects the thickness unevenness of the resin layers in the disk plane, so the lower is the degree of parallelism between the squeegee 102 and the table 106, the better. Also, the squeegee fixing jig 101 is preferably made of a material with excellent rigidity, such as stainless steel.

The squeegee 102 is preferably made of a material that is chemical stable with respect to the ultraviolet curing resin 103, and that exhibits rubber-like elasticity. This is because during printing, the squeegee 102 is repeatedly rubbed against the gauze of the screen 104 in a state of being in contact with the ultraviolet curing resin 103.

Next, the screen 104 is put in place. Here again, just as with the squeegee 102, the degree of parallelism with the table 106 is important.

Then, information layers containing a recording film material or reflective film material are formed on the upper surface of the signal substrate 107 by sputtering, vapor deposition, or another such method on the side on which the information face (pits or guide grooves) is formed, with an intermediate layer sandwiched in between, thus the multilayer thin-film layer 108′ is formed. If needed, the opposite side from the side on which the multilayer thin-film layer 108′ is formed is fixed on the table 106 by vacuum chucking or other such means.

Meanwhile, the screen 104 is provided so that the film can be formed in a uniform thickness by limiting the amount of ultraviolet curing resin 103 that passes through the openings.

The method for producing the screen 104 will not be described, since it is the same as what was discussed above. Nor will the relation between the screen and the coated region of the signal substrate be described, since it is the same as in the above embodiment.

As shown in FIG. 14A, the ultraviolet curing resin 103 is dripped ahead of the squeegee 102 in its forward direction. In this embodiment, the viscosity of the ultraviolet curing resin 103 is 4000 cps, and the mesh count of the screen 104 is 70. The viscosity of the ultraviolet curing resin used to form the first resin layer is preferably from 500 to 10,000 cps.

In FIG. 14B, the squeegee 102 is rubbed while being pushed into the screen 104 in the direction of the arrow 109, which coats the signal substrate 107 with the ultraviolet curing resin 103. This operation causes a first type of ultraviolet curing resin 103 to be pushed in and pass downward through an opening area between the threads of the screen 104, and coating with the resin is possible by bringing this into contact with the multilayer thin-film layer 108′.

FIG. 14C shows the first type of resin layer 110 that has been formed. This coating step allows the first type of resin layer 110 to be formed in an average thickness of 55 μm. The surface shape of the first type of resin layer 110 is to a great extent due to the characteristics of the ultraviolet curing resin 103 and to the separation of the screen 104. The center line average roughness Ra of the surface immediately after the formation of the ultraviolet curing resin 103 here is 14 μm.

In FIG. 14D, the first type of resin layer 110 is cured using an ultraviolet irradiation device 111 from above the first type of resin layer 110.

In FIG. 14E, the signal substrate 107 is moved below a screen 113 that applies a second type of ultraviolet curing resin 112, in a state in which the cured first type of resin layer 110 is on top. In this step, the viscosity of the second type of ultraviolet curing resin 112 is 100 cps, and the mesh count of the screen 113 is 300. Just as in the previous step, a squeegee 115 is fixed by a squeegee fixing jig 114.

In FIG. 14F, just as in the step of FIG. 1B, the squeegee fixing jig 114 and the squeegee 115 are pushed into the screen 113 while being moved in the direction of the arrow 116. The second type of ultraviolet curing resin 112 is passed through the opening area between the threads of the screen 113, and a second type of resin layer is formed over the cured first type of resin layer 110.

FIG. 14G shows the second type of resin layer 117 formed in an average thickness of 5 μm and in contact with the first type of resin layer 110. Since the second type of resin layer 117 here is low in viscosity, it fills in the recesses in the first type of resin layer 110, providing a leveling action that corrects surface roughness of the first type of resin layer 110. If an ultraviolet curing resin with a high surface tension is selected for the second type of ultraviolet curing resin 112, there will be a greater force that acts to reduce surface area of the second type of resin layer 117, that is, the atmosphere contact area, so the effect is to enhance the leveling action. Also, leaving a longer time from the coating with the second type of resin layer 117 until the curing of the resin allows the second type of resin layer 117 to move, which improves the surface condition.

In FIG. 14H, after the second type of resin layer 117 has been applied and leveling completed, an ultraviolet irradiation device 118 is used to bathe the coating in ultraviolet rays and cure the second type of resin layer 117. The center line average roughness of the second type of resin layer 117 after curing is 1 μm or less.

Thus, with a cover layer composed of the first type of resin layer 110 and the second type of resin layer 117, the center line average roughness of the surface of the second type of resin layer 117 is less than the center line average roughness of the surface of the first type of resin layer 110.

It is important for a thick-film resin layer of about 60 μm, as in this embodiment, to be formed by screen printing, and, to improve the surface condition, for the viscosity of the first type of resin to be greater than the viscosity of the second type of resin.

Another condition is that when the second resin layer is also formed by screen printing, it is important for the mesh count of the screen used in forming the first resin layer to be less than the mesh count of the screen used in forming the second resin layer.

According to the above conditions, at least half of the desired thickness is formed by the thickness of the first type of resin layer.

Next, the surface condition of each resin layer will be described. In this embodiment, the center line average roughness Ra of the surface of the first type of resin layer 110 is 14 μm, as mentioned above. This center line average roughness is measured according to standard No. JIS B 0601. In the case of screen printing, this center line average roughness Ra is generally proportional to the coating film thickness. This is because if the goal is to apply a thick coating of the resin layer, a large opening area must be obtained by using a coarse screen that has thick threads.

The resin coating thickness and the mesh shape of the screen are the same as in the above embodiments, and therefore will not be described again. The effect of this embodiment is also the same as that in the above embodiments.

### OTHER EMBODIMENTS

Embodiments of the present invention were described above, but the present invention is not limited to or by these embodiments, and various modifications are possible without departing from the gist of the invention.

In Embodiment 2, a method is disclosed in which the surface condition of a first layer of ultraviolet curing resin is improved by forming the first layer of ultraviolet curing resin by screen printing, and then affixing a substrate with an excellent surface condition in a vacuum atmosphere. This method can also be applied to a combination of screen printing and screen printing (Embodiment 1), or a combination of screen printing and inkjetting (Embodiment 3).

In Embodiment 4, screen printing and screen printing are combined to produce a signal substrate that is an intermediate layer, and not just a cover layer. A combination of screen printing and spin coating (Embodiment 2) or a combination of screen printing and inkjetting (Embodiment 3) may also be used to produce a signal substrate that is an intermediate layer.

In the above embodiments, a cover layer or an intermediate layer is formed by two resin application steps, but the resin application step may be performed three or more times, in which case two or more types of ultraviolet curing resin may be used. In this case, the viscosity of the resin that is applied last is preferably lower than the viscosity of the other resins, and must be lower than the viscosity of the resin applied first. As a result, the center line average roughness of the outermost resin layer will be lower than the center line average roughness of the first resin layer surface.

Alternatively, the above-mentioned effect will also be obtained when the center line average roughness of the surface of the first resin layer to be formed on the information recording layer is greater than the center line average roughness of the surface of the resin layers besides the first resin layer. It is particularly favorable for the center line average roughness of the first resin layer surface to be greater than the center line average roughness of the outermost resin layer.

### INDUSTRIAL APPLICABILITY

The multilayer recording medium and method for manufacturing the same pertaining to the present invention make it possible to manufacture a multilayer recording medium with few defects at high speed, and are useful as a multilayer recording medium with which a large volume of information can be reproduced accurately, a means for applying a liquid resin uniformly, and so forth. The invention can also be applied to the manufacture of a large-capacity memory and other such applications.

1-10. (canceled)

11. A method for manufacturing an information recording medium, the information recording medium having an information recording layer which a signal is recorded on and reproduced from by a laser beam directed at the information recording medium and a resin layer on a side of the information recording layer at which the laser beam is directed, the resin layer includes at least two kinds of ultraviolet curing resin, the method comprising:
forming a first resin layer on the information recording layer by coating with a liquid first ultraviolet curing resin by screen printing; and
forming a second resin layer by coating with a second ultraviolet curing resin having a lower viscosity than the first ultraviolet curing resin by screen printing, so that the second resin layer comes into contact with the first resin layer and the thickness of the first resin layer is greater than the thickness of the second resin layer.

12. The method for manufacturing an information recording medium according to claim 11, wherein the mesh count of the screen used in the screen printing to form the second resin layer is greater than the mesh count of the screen used in the screen printing to form the first resin layer.

13. The method for manufacturing an information recording medium according to claim 11, further comprising the steps of:
affixing a substrate with a flat surface under a vacuum atmosphere to an information recording medium obtained by forming the first resin layer by screen printing with the liquid first ultraviolet curing resin;
directing ultraviolet rays at the information recording medium and the flat substrate in a state in which they have been affixed; and
peeling the information recording medium and the flat substrate apart.

14. The method for manufacturing an information recording medium according to claim 11, wherein, in a step following the coating of the first ultraviolet curing resin, ultraviolet rays are directed at the first ultraviolet curing resin for the purpose of curing it.

15. An information recording medium comprising:
an information recording layer,
and at least two resin layers formed over the information recording layer, where the resin layers include a first resin layer formed on the information recording layer, and a center line average roughness of the first resin layer surface is greater than a center line average roughness of the resin layer surfaces other than the first resin layer.

16. The information recording medium according to claim 15, wherein the center line average roughness of the first resin layer surface is greater than the center line average roughness of the outermost resin layer.

17. The method for manufacturing an information recording medium according to claim 12, further comprising the steps of:
affixing a substrate with a flat surface under a vacuum atmosphere to an information recording medium obtained by forming the first resin layer by screen printing with the liquid first ultraviolet curing resin;
directing ultraviolet rays at the information recording medium and the flat substrate in a state in which they have been affixed; and
peeling the information recording medium and the flat substrate apart.

18. The method for manufacturing an information recording medium according to claim 12, wherein, in a step following the coating of the first ultraviolet curing resin, ultraviolet rays are directed at the first ultraviolet curing resin for the purpose of curing it.

19. The method for manufacturing an information recording medium according to claim 13, wherein, in a step following the coating of the first ultraviolet curing resin, ultraviolet rays are directed at the first ultraviolet curing resin for the purpose of curing it.
